(19) United States
(12) Patent Application Publication
(10) Pub. No.: US 2011/0058812 A1
(43) Pub. Date: Mar. 10, 2011

(54) Optically Enabled Broadcast Bus

(76) Inventors: Michael Renne Ty Tan, Menlo Park, CA (US); Moray Mclaren, Bristol (GB); Joseph Straznicky, Santa Rosa, CA (US); Paul Kessler Rosenberg, Sunnyvale, CA (US); Huei Pei Kuo, Cupertino, CA (US)

(21) Appl. No.: 12/991,662

(22) PCT Filed: May 9, 2008
(86) PCT No.: PCT/US08/05992

§ 371 Date: Nov. 8, 2010

(51) Int. Cl. H04J 14/00

(52) U.S. Cl. 398/66

(57) ABSTRACT

Embodiments of the present invention are directed to optical multiprocessing buses. In one embodiment, an optical broadcast bus includes a repeater, a fan-in bus optically coupled to a number of nodes and the repeater, and a fan-out bus optically coupled to the nodes and the repeater. The fan-in bus is configured to receive optical signals from each node and transmit the optical signals to the repeater, which regenerates the optical signals. The fan-out bus is configured to receive the regenerated optical signals output from the repeater and distribute the regenerated optical signals to the nodes. The repeater can also serve as an arbiter by granting one node at a time access to the fan-in bus.

### TECHNICAL FIELD

Embodiments of the present invention are related to optics, and, in particular, to optical broadcast buses.

### BACKGROUND

Typical electronic broadcast buses are comprised of a collection of signal lines that interconnect nodes. A node can be a processor, a memory controller, a server blade of a blade system, a core in a multi-core processing unit, a circuit board, an external network connection. The broadcast bus allows a node to broadcast messages such as instructions, addresses, and data to nodes of a computational system. Any node in electronic communication with the bus can receive messages sent from the other nodes. However, the performance and scalability of electronic broadcast buses is limited by issues of bandwidth, latency, and power consumption. As more nodes are added to the system, there is more potential for activity affecting bandwidth and a need for longer interconnects, which increases latency. Both bandwidth and latency are satisfied with more resources, which results in increases in power. In particular, electronic broadcast buses tend to be relatively large and consume a relatively large amount of power, and scaling in some cases can be detrimental to performance.

Accordingly, a scalable broadcast bus that exhibits low-latency and high-bandwidth is desired.

### SUMMARY

Embodiments of the present invention are directed to optical multiprocessing buses. In one embodiment, an optical broadcast bus includes a repeater, a fan-in bus optically coupled to a number of nodes and the repeater, and a fan-out bus optically coupled to the nodes and the repeater. The fan-in bus is configured to receive optical signals from each node and transmit the optical signals to the repeater, which regenerates the optical signals. The fan-out bus receives the regenerated optical signals output from the repeater and distributes the regenerated optical signals to the nodes. The repeater can also serve as an arbiter by granting one node at a time access to the fan-in bus.

### BRIEF DESCRIPTION OF THE DRAWINGS

FIG. 1 shows a schematic representation of an optical multiprocessing bus configured in accordance with embodiments of the present invention.

FIG. 2 shows a schematic representation of a beamsplitter configured in accordance with embodiments of the present invention.

FIG. 3A shows how a fan-out bus of the optical multiprocessing bus, shown in FIG. 1, distributes optical power to nodes of a computational system in accordance with embodiments of the present invention.

FIG. 3B shows how a fan-in bus of the optical multiprocessing bus, shown in FIG. 1, provides an equal amount of optical power output from nodes of a computational system to a repeater in accordance with embodiments of the present invention.

FIG. 4 shows a schematic representation of an optical multiprocessing bus configured with delay matching in accordance with embodiments of the present invention.

FIG. 5A show a schematic representation of a first light U-turn system configured in accordance with embodiments of the present invention.

FIG. 5B shows a schematic representation of a second light U-turn system configured in accordance with embodiments of the present invention.

FIG. 6 shows a first symmetric optical multiprocessing bus configured in accordance with embodiments of the present invention.

FIG. 7 shows a second symmetric optical multiprocessing bus configured in accordance with embodiments of the present invention.

FIG. 8 shows a third symmetric optical multiprocessing bus configured in accordance with embodiments of the present invention.

FIG. 9A shows a schematic representation of a first splitter/combiner configured in accordance with embodiments of the present invention.

FIG. 9B shows a schematic representation of a second splitter/combiner configured in accordance with embodiments of the present invention.

### DETAILED DESCRIPTION

Embodiments of the present invention are directed to optical multiprocessing broadcast buses, each of which is composed of a fan-in bus and a fan-out bus. The fan-in and fan-out buses are connected through a repeater. An optical signal generated by a node is sent to the repeater on the fan-in bus where the optical signal is regenerated and broadcast to all of the nodes on the fan-out bus. The repeater can also serve as an arbiter that grants one node at a time access to the fan-in bus. The optical multiprocessing buses can be configured for symmetric multiprocessing where each node on the bus can access or communicate with every other node attached to the bus. The optical multiprocessing buses are enabled by using optical taps that distribute the optical power equally among the nodes over the fan-out bus and ensures that a substantially equal amount of optical power is sent to the repeater from each node on the fan-in bus.

For the sake of brevity and simplicity, system embodiments are described below with reference to computer systems having four and eight nodes. However, embodiments of the present invention are not intended to be so limited. Those skilled in the art will immediately recognize that optical multiprocessing bus embodiments can be scaled up to provide optical communications for computer systems composed of any number of nodes.

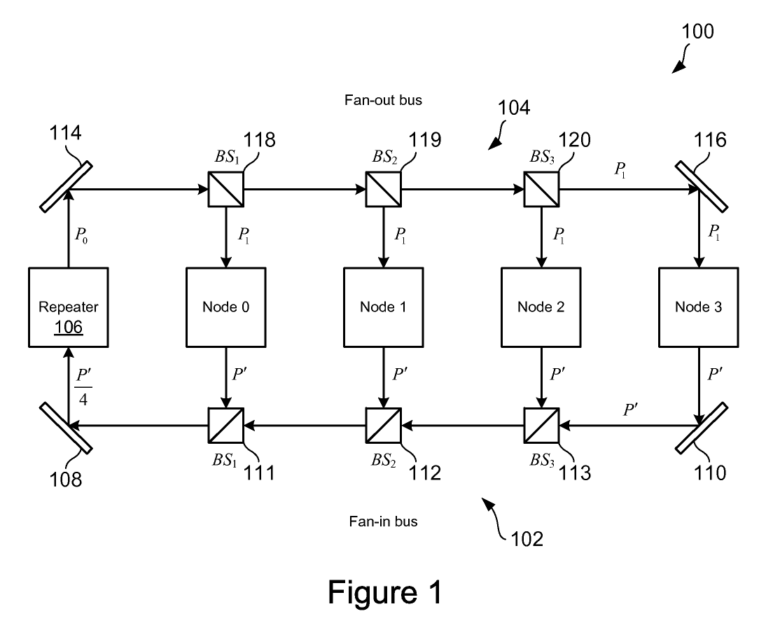

FIG. 1 shows a schematic representation of an optical multiprocessing bus 100 configured in accordance with embodiments of the present invention. The optical bus 100 includes a fan-in bus 102, a fan-out bus 104, and a repeater 106. The fan-in bus 102 includes mirrors 108 and 110 and three optical taps 111-113. The fan-out bus 104 includes mirrors 114 and 116 and three optical taps 118-120. Four nodes labeled 0 through 3 are positioned between the fan-in and fan-out buses 102 and 104. The nodes can be any combination of processors, memory controllers, server blades of a blade system, clusters of multi-core processing units, circuit boards, external network connections, or any other data processing, storing, or transmitting device. Nodes 0-3 include electrical-to-optical converters (not shown) that convert electronic data signals generated within each node into optical signals that are sent over the fan-in bus 102 to the repeater 106. Nodes 0-3 also include optical-to-electrical converters (not shown) that convert optical signals sent by the repeater 106 over the fan-out bus 104 into electronic data signals that can be processed by nodes 0-3.

As shown in the Example of FIG. 1, directional arrows represent the direction optical signals propagate along optical communication paths of the fan-in and fan-out buses 102 and 104. The term “optical communication path” refers to optical interconnects and to light transmitted through free space. The optical interconnects can be hollow waveguides composed of a tube with an air core. The structural tube forming the hollow waveguide can have inner core materials with refractive indices greater than or less than one. The tubing can be composed of a suitable metal, glass, or plastic and metallic and dielectric films can be deposited on the inner surface of the tubing. The hollow waveguides can be hollow metal waveguides with high reflective metal coatings lining the interior surface of the core. The air core can have a cross-sectional shape that is circular, elliptical, square, rectangular, or any other shape that is suitable for guiding light. Because the waveguide is hollow, optical signals can travel along the core of a hollow waveguide with an effective index of about 1. In other words, light propagates along the core of a hollow waveguide at the speed of light in air or vacuum.

The repeater 106 is an optical-to-electrical-to-optical converter that receives optical signals reflected off of mirror 108, regenerates the optical signals, and then retransmits the regenerated optical signals to the mirror 114. The repeater 106 can be used to overcome attenuation caused by free-space or optical interconnect loss. In addition to strengthening the optical signals, the repeater 106 can also be used to remove noise or other unwanted aspects of the optical signals. The amount of optical power produced by the repeater 106 is determined by the number of nodes attached to the fan-out bus, the system loss and the receiver sensitivity. In other words, the repeater 106 can be used to generate optical signal with enough optical power to reach all of the nodes.

The repeater 106 can also include an arbiter that resolves conflicts by employing an arbitration scheme that prevents two or more nodes from simultaneously using the fan-in bus 102. In many cases, the arbitration carried out by the repeater 106 lies on the critical path of computer system performance. Without arbitration, the repeater 106 could receive optical signals from more that one node on the same optical communication path, where the optical signals combine and arrive indecipherable at the repeater 106. The arbiter ensures that before the fan-in bus 102 can be used, a node must be granted permission to use the fan-in bus 102, in order to prevent simultaneous optical signal transmissions to the repeater 106. It is also critical that arbitration be precise and fast and must scale as the number of nodes are added to the bus 100. Arbitration can be carried out by the arbiter using well-known optical or electronic, token-based arbitration methods. For example, the arbiter can distribute a token representing exclusive access to the fan-in bus 102. A node in possession of the token has exclusive access to the fan-in bus 102 for a specific period of time. When the node is finished using the fan-in bus 102, the node can be responsible for replacing the token so that other nodes can have access to the fan-in bus 102.

The optical signals broadcast by nodes 0-3 over the fan-in and fan-out buses 102 and 104 can be in the form of packets that include headers. Each header identifies a particular node as the destination for data carried by the optical signals. All of the nodes receive the optical signals over the fan-out bus 104. However, because the header of each packet identifies a particular node as the destination of the data, only the node identified by the header actually receives and operates on the optical signals. The other nodes also receive the optical signals, but because they are not identified by the header they discard the optical signals.

The optical taps of the fan-out bus 104 are configured to distribute the optical power approximately equally among the nodes. In general, the optical taps are configured to divert about 1/nth of the total optical power of an optical signal output from a repeater to each of the nodes, where n is the number of nodes. The optical taps of the fan-in bus are configured so that an equal amount of optical power is received by the repeater from each node on the fan-in bus. In other words, the optical taps are configured in the fan-in bus so that the repeater receives about 1/nth of the total optical power output from each node.

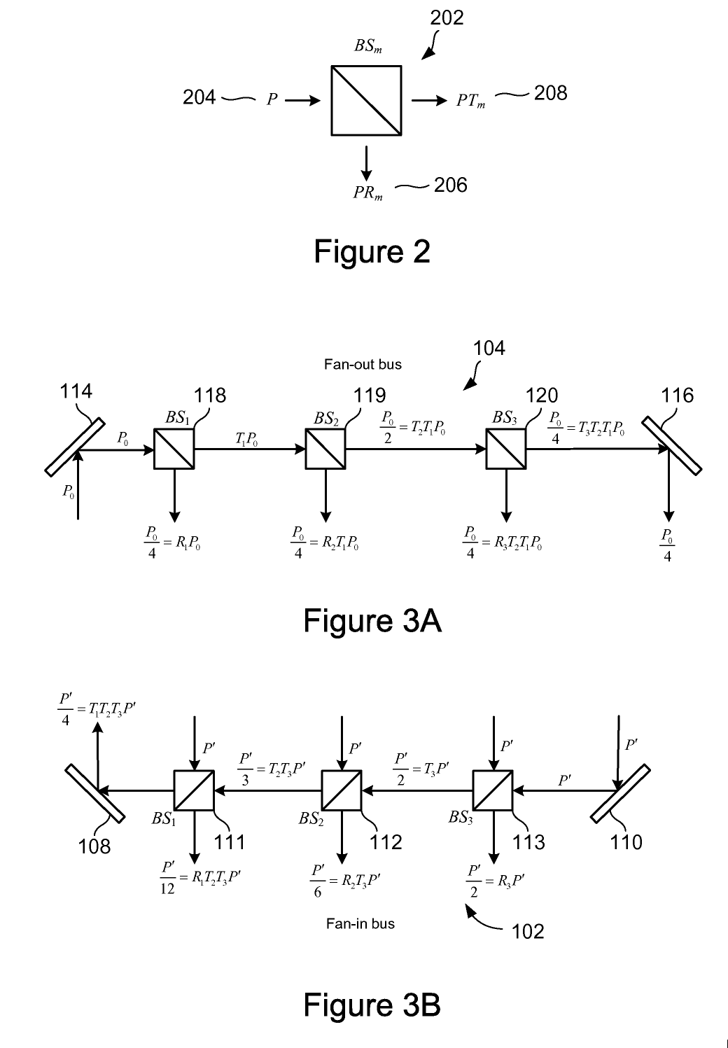

Beamsplitters are a kind of optical tap that can be used in the fan-in and fan-out buses. FIG. 2 shows a schematic representation of a beamsplitter 202 configured in accordance with embodiments of the present invention. The beamsplitter 202 identified by BSₘ is configured to reflect a fraction of the optical signal power P 204 input to the beamsplitter 202 in accordance with:

$${R}_{m} = \frac{1}{( n - m + 1 )}$$

and transmit a fraction of the optical signal power P 204 in accordance with:

$${T}_{m} = \frac{( n - m )}{( n - m + 1 )}$$

where ideally Rₘ+Tₘ=1, and m is an integer representing a beamsplitter located along the optical communication paths of the fan-in and fan-out buses such that 1≦m≦n−1, 1 represents the beamsplitter located closest to the repeater and n−1 represents the beamsplitter located farthest from the repeater. Thus, the beamsplitter BSₘ 202 receiver an optical signal with optical power P 204, outputs a reflected portion with optical power PRₘ 206, and outputs a transmitted portion with optical power PTₘ 208, where P=PRₘ+PTₘ.

As shown in the example of FIG. 1, the beamsplitters BS₁, BS₂, and BS₃ used in the fan-in bus 102 are identical to the beamsplitters used in the fan-out bus 104, however, the beamsplitters 111-113 of the fan-in bus 102 are oriented so that an equal amount of optical power is received by the repeater 106 from each node on the fan-in bus 102, and the beamsplitters 118-120 are oriented to distribute the optical power of the optical signal output from the repeater 106 approximately equally among nodes 0-3. In particular, according to the reflectance Rₘ and the transmittance Tₘ above, the beamsplitter BS₁ has an R₁ of ¼ and a T₁ of ¾, BS₂ has an R₂ of ⅓ and a T₂ of ⅔, and BS₃ has an R₃ of ½ and a T₃ of ½. FIG. 3A reveals how the beamsplitters BS₁ 118, BS₂ 119, and BS₃ 120 of the fan-out bus 104 are configured and oriented so that the optical power of the optical signal received by each node is P₀/4, where P₀ is the power of the optical signal output from the repeater 106. FIG. 3B reveals how the beamsplitters BS₁ 111, BS₂ 112, and BS₃ 113 of the fan-in bus 102 are configured and oriented so that the optical power of the optical signal received by the repeater 106 is approximately P′/4, where P′ is the power of the optical signal output from each of nodes 0-3.

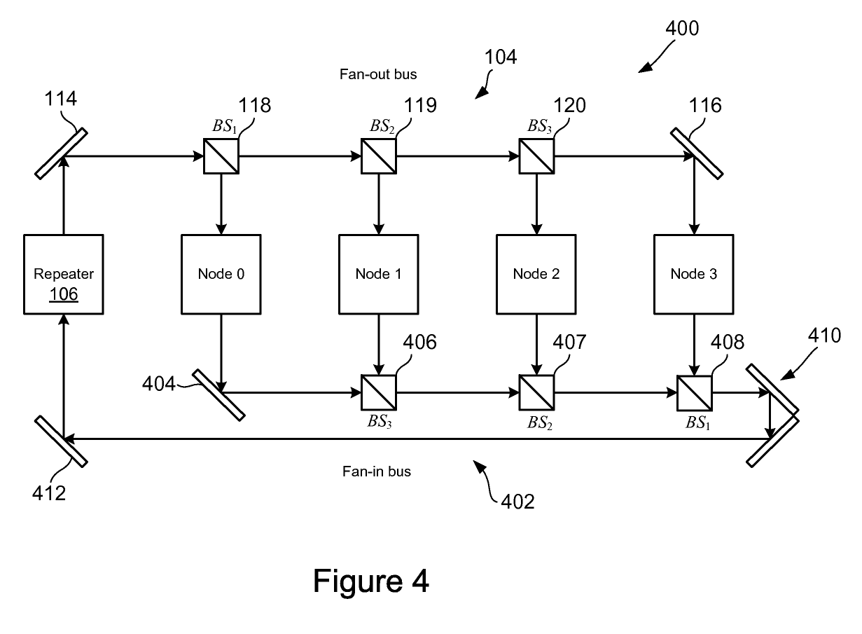

FIG. 4 shows a schematic representation of an optical multiprocessing bus 400 with delay matching configured in accordance with embodiments of the present invention. The optical bus 400 is nearly identical to the bus 100, shown in FIG. 1, except the fan-in bus 102 has been replaced by a fan-in bus 402 comprising a mirror 404, three beamsplitters 406-408, a light U-turn system 410, and a mirror 412 that directs optical signals output form each node 0-3 to the repeater 106. The fan-in bus 402 ensures that the round trip path length or distance an optical signal travels back to the node it originated from is approximately the same for all nodes. For example, examination of the bus 400 reveals that the round trip path length of an optical signal generated by node 3 back to itself is substantially the same as the round trip path length of an optical signal generated by node 1 back to itself. By contrast, examination of the bus 100 reveals that the path length of an optical signal generated by node 3 back to itself is longer than the path length of an optical signal generated by node 1 back to itself. Because the length of time for optical signals to be transmitted around the bus 400 is substantially the same, the input and output of optical signals of every node can be timed in accordance with a system clock.

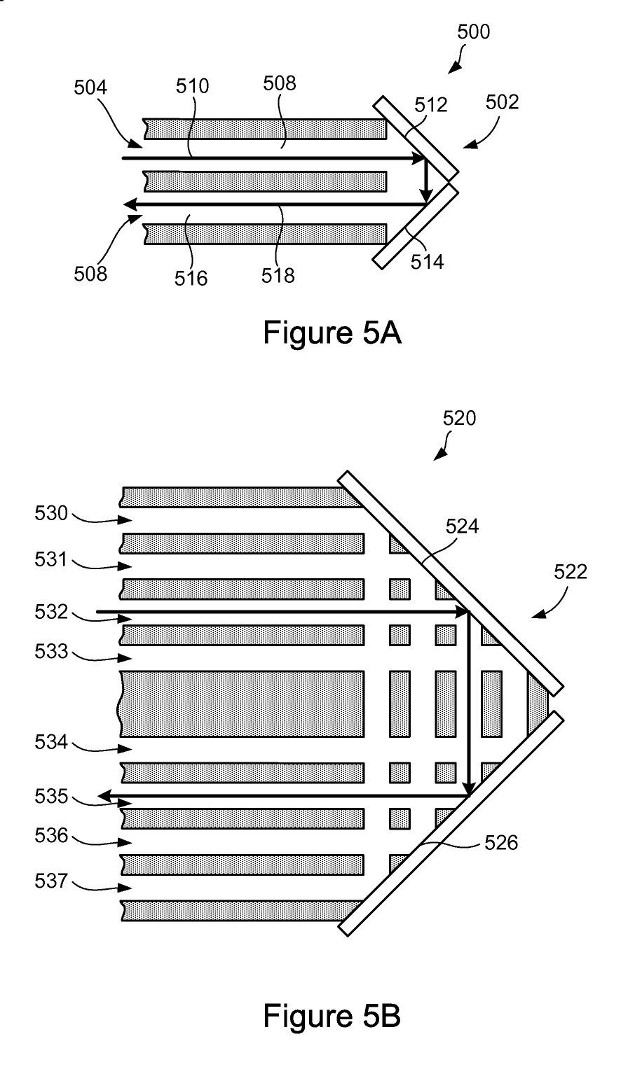

FIG. 5A show schematic representations of a light U-turn system 500 configured in accordance with embodiments of the present invention. The U-turn system 500 includes a reflective structure 502, a hollow input waveguide 504 and a hollow output waveguide 506 vertically stacked located proximate to the reflective surface 502. Directional arrows represent the paths light travels through and is turned around within the U-turn system 500. In particular, light transmitted along the core 508 of the hollow input waveguide 504 in a first direction 510 emerges from the hollow input waveguide 504 and is reflected off of a first reflective surface 512 to a second reflective surface 514 of the reflective structure 502. The light is then reflected off of the second reflective surface 514 into the core 516 of the hollow output waveguide 508 in a second direction 518 that is opposite the first direction 510. FIG. 5B shows a schematic representation of a light U-turn system 520 having four U-turns configured in accordance with embodiments of the present invention. The U-turn system 520 includes a reflective structure 522 composed a first reflective surface 524 and a second reflective surface 526, hollow input waveguides 530-533 that terminate proximate to the reflective surface 524, and corresponding hollow output waveguides 534-537 that terminate proximate to the reflective surface 526. The hollow waveguides 530-537 lie in the same plane. Directional arrows represent one of four U-turn paths the optical signal travel through the U-turn system 520.

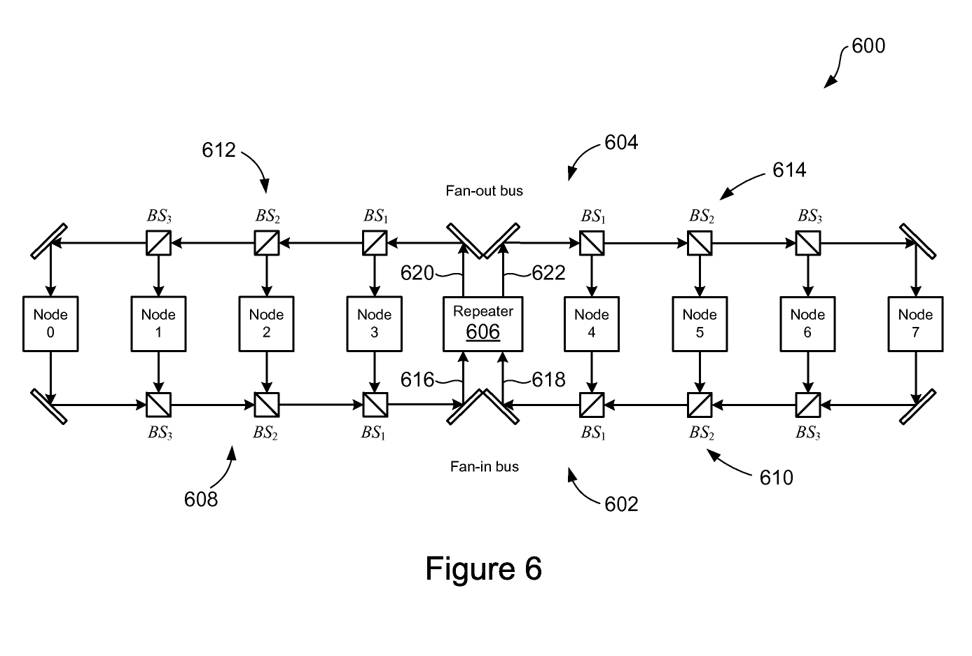

In other optical multiprocessing bus embodiments, rather than placing the repeater at the end of the nodes as is done with the optical multiprocessing bus 100 described above, the repeater can be centrally disposed between the nodes, in order to reduce the amount of optical power needed to send an optical signal to the repeater and reduce the amount optical power needed to broadcast optical signals to all of the nodes. FIGS. 6-10 show a number of different optical multiprocessing bus configurations. The optical processing bus embodiments described below all include the same fan-in and fan-out buses 102 and 104 described above with reference to the bus 100 as portions of larger fan-in and fan-out buses. Thus, a detailed description of the operation and function of the larger fan-in and fan-out buses is not repeated.

FIG. 6 shows a first symmetric optical multiprocessing bus 600 configured in accordance with embodiments of the present invention. The bus 600 is composed of a fan-in bus 602 and a fan-out bus 604. A repeater 606 is disposed in the middle of nodes 0-7. The repeater 606 may include an arbiter that controls which of nodes 0-7 is granted access to the fan-in bus 602. The fan-in bus 602 is composed of a first fan-in portion 608 that directs optical signals output from each of nodes 0-3 to the repeater 606 and a second fan-in portion 610 that directs optical signals output from each of nodes 4-7 to the repeater 606. The repeater 606 can be configured to separately receive optical signals from the first fan-in portion 608 and the second fan-in portion 610. The fan-out bus 604 is composed of a first fan-out portion 612 that broadcast optical signals output from the repeater 606 to nodes 0-3 and a second fan-out portion 614 that broadcast optical signals output from the repeater 606 to nodes 4-7. The repeater 606 receives optical signals output from one of nodes 0-7 over either the fan-in portion 608 or the fan-in portion 610 along the optical communication paths 616 and 618, respectively, and simultaneously generates two regenerated optical signals that are output on the optical communication paths 620 and 622, respectively. The regenerated optical signals are then simultaneously broadcast to nodes 0-7 over the first and second fan-out portions 612 and 614 of the fan-out bus 604.

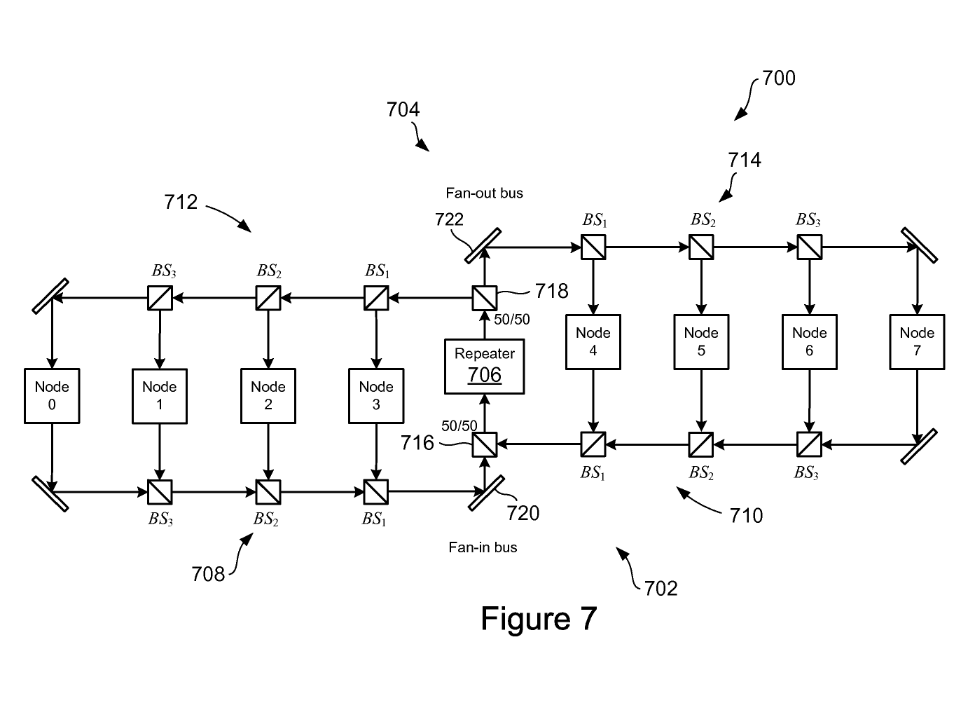

FIG. 7 shows a second symmetric optical multiprocessing bus 700 configured in accordance with embodiments of the present invention. The bus 700 is composed of a fan-in bus 702 and a fan-out bus 704. A repeater 706 is disposed in the middle of nodes 0-7. The repeater 706 may include an arbiter that controls which of nodes 0-7 is granted access to the fan-in bus 702. The fan-in bus 702 is composed of a first fan-in portion 708 that directs optical signals output from each of nodes 0-3 to the repeater 706 and a second fan-in portion 710 that directs optical signals output from each of nodes 4-7 to the repeater 706. The fan-out bus 704 is composed of a first fan-out portion 712 that broadcast optical signals output from the repeater 706 to nodes 0-3 and a second fan-out portion 714 that broadcast optical signals output from the repeater each of nodes 4-7 to the repeater 706. As shown in the example of FIG. 7, the fan-in bus 702 and the fan-out bus 704 also include 50/50 beamsplitters 716 and 718, respectively. An optical signal output from one of nodes 0-3 passes through the first fan-in portion 708 and is directed by a mirror 720 to the beamsplitter 716, where the transmitted portion of the optical signal is received by the repeater 706. An optical signal output from one of nodes 4-7 passes through the second fan-in portion 710 to the beamsplitter 716, where the reflected portion is received by the repeater 706. An optical signal output from the repeater 718 is split into a reflected optical signal that is broadcast to nodes 0-3 over fan-out portion 712 and a transmitted optical signal that is reflected by a mirror 722 and broadcast to nodes 4-7 over fan-out portion 714.

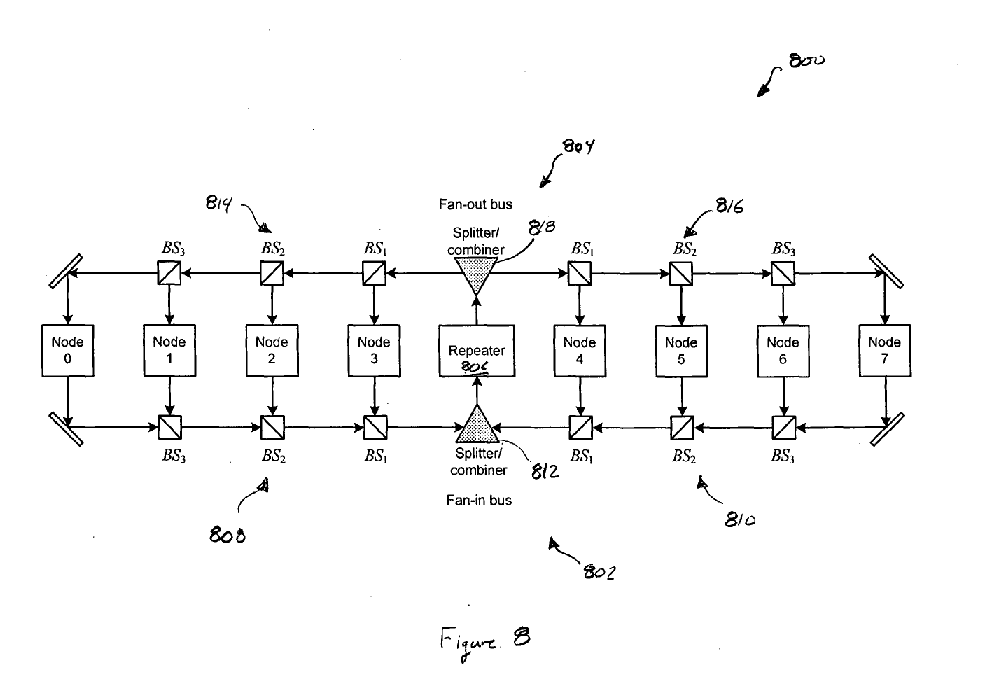

FIG. 8 shows a third symmetric optical multiprocessing bus 800 configured in accordance with embodiments of the present invention. The bus 800 is composed of a fan-in bus 802 and a fan-out bus 804. A repeater 806 is disposed in the middle of nodes 0-7. The repeater 806 may include an arbiter that controls which of nodes 0-7 is granted access to the fan-in bus 802. The fan-in bus 802 is composed of a first fan-in portion 808 and a second fan-in portion 810 both of which are coupled to a first splitter/combiner 812. The fan-in portion 808 and the fan-in portion 810 direct optical signals output from each of nodes 0-7 to the first splitter/combiner 912 where the optical signals are directed to the repeater 806. The fan-out bus 804 is composed of a first fan-out portion 814 and a second fan-out portion 816, both of which are coupled to a second splitter/combiner 818. The repeater 806 outputs optical signals to splitter/combiner 818 which splits the optical signals that are broadcast to nodes 0-3 over the fan-out portion 814 and to nodes 4-7 over the second fan-out portion 816.

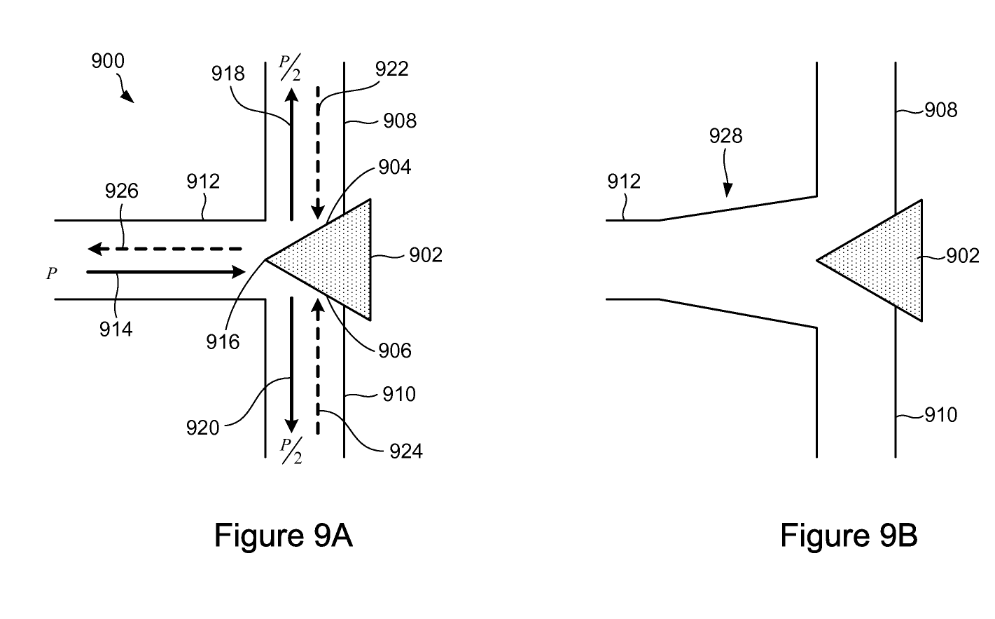

FIG. 9A shows a schematic representation of a splitter/combiner 1000 configured in accordance with embodiments of the present invention. The splitter/combiner 900 includes a prism 902 with a first reflective planar surface 904 and a second reflective planar surface 906. The splitter/combiner 900 also includes a first waveguide portion 908, a second waveguide portion 910, and a main waveguide portion 912. As shown in the example of FIG. 9A, the first and second waveguide portions 908 and 910 are disposed substantially perpendicular to the main waveguide portion 912. The waveguide portions 908, 910, and 912 can be optical fibers or hollow waveguides. The splitter/combiner 900 can be operated as a 50/50 beamsplitter for incident light propagating in the main waveguide 912 toward the prism 902, as indicated by directional arrow 914. The light is split at the edge 916 into a first beam of light and a second beam of light, each beam carrying substantially one-half of the optical power of the incident beam of light. The angle between reflective surfaces 904 and 906 is selected so that the first beam of light is reflected off of the first reflective surface 904 and propagates along the first waveguide 908 in the direction 918, and the second beam of light is reflected off of the second reflective surface 906 and propagates along the second waveguide 910 in the direction 920.

The splitter/combiner 900 can also be operated as a light combiner. For example, a first incident beam of light propagating in the first waveguide portion 908 toward the prism 902 in the direction 922 is reflected off of the first reflective surface 904 into the main waveguide 912, and a second incident beam of light propagating in the second waveguide portion 910 toward the prism 902 in the direction 924 is reflected off of the second reflective surface 906 into the main waveguide 912. The first and second beams of light combine within the main waveguide and propagate in the direction 926. The prism angle is chosen to minimize the insertion loss of the splitter/combiner junction. A 90 degree angle prism has a splitter efficiency of better than 93%.

In other embodiments, the main waveguide 912 can be configured with a tapered region 928, as shown in FIG. 9B. The tapered region 928 can be used to spread light traveling along the main waveguide 912 as it reaches the prism 902, or the tapered region 928 can be used to improve the loss of the combiner/splitter junction by funneling the light reflected into the waveguide 912 from waveguides 908 and 910. An efficiency of greater than 78% is predicted for the combiner.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An optical broadcast bus comprising:
a repeater configured to regenerate optical signals;
a fan-in bus optically coupled to a number of nodes and the repeater, the fan-in bus configured to receive optical signals from each node and transmit the optical signals to the repeater; and
a fan-out bus optically coupled to the nodes and the repeater, the fan-out bus configured to receive the regenerated optical signals output from the repeater and distribute the regenerated optical signals to each of the nodes.

2. The broadcast bus of claim 1 wherein the repeater is an optical-to-electrical-to-optical converter that receives the optical signals from the fan-in bus, regenerates the optical signals, then transmits the regenerated optical signals on the fan-out bus, and includes arbitration to determine which of the nodes has permission to send optical signal over in the fan-in bus.

3. The broadcast bus of claim 1 wherein the fan-in and fan-out buses further comprise:
a number of optical communication paths;
a first set of optical taps configured and oriented to direct optical signals output from each node over certain optical communication paths to the repeater; and
a second set of optical taps configured and oriented to divert a portion of the regenerated optical signals output from the repeater to the nodes.

4. The broadcast bus of claim 3 wherein the optical communication paths further comprises hollow waveguides through which the optical signals propagate.

5. The broadcast bus of claim 3 wherein the optical taps further comprise beamsplitters.

6. The broadcast bus of claim 1 wherein the fan-in bus configured to receive optical signals from each node and transmit the optical signals to the repeater further comprises the fan-in bus transmitting a substantially equal amount of optical power to the repeater.

7. The broadcast bus of claim 1 wherein the fan-out bus configured to distribute the regenerated optical signals output from the repeater to each of the nodes further comprises each node receiving a portion of the regenerated optical signal wherein each portion having substantially the same optical power.

8. The broadcast bus of claim 1 further comprising symmetric placement of the repeater between nodes, wherein the repeater is disposed between first and second portions of the fan-in bus and between a first and second portion of the fan-out bus so that a second portion of the nodes to reduce maximum delay and power needed to broadcast the regenerated optical signals to the nodes.

9. The broadcast bus of claim 8 wherein optical signals that are input to the repeater from the first and second portions of the fan-in bus through a first splitter/combiner and are output from the repeater to the first and second portion of the fan-out bus through a second splitter/combiner

10. The broadcast bus of claim 9, wherein the splitter/combiner comprises:
a prism having a reflective surface;
a first hollow waveguide portion having an end disposed proximate to a first portion of the reflective surface;
a second hollow waveguide portion having an end disposed proximate to the second portion of the reflective surface; and
a main hollow waveguide portion disposed so that light emerging from the main hollow waveguide is split into a first beam that enters the first hollow waveguide and a second beam that enters the second hollow waveguide, and light emerging from the first and second hollow waveguides is reflected off of the first portion and the second portion and combined within the main hollow waveguide.

11. The broadcast bus of claim 10 wherein the hollow waveguides further comprises an air core having a cross-sectional shape that is circular, elliptical, square, rectangular, or any other shape that is suitable for guiding light.

12. The broadcast bus of claim 10 wherein the main hollow waveguide taper away from the prism edge.

13. The broadcast bus of claim 1 further comprises an extended fan-in bus optical communication path length so that the complete round trip path length of any optical signal generated by a node back to itself is always approximately the same.

14. The broadcast bus of claim 13 wherein the extended fan-in bus optical communication path length further comprises a light U-turn system including:
a reflective structure;
a hollow input waveguide having an opening disposed proximate to the reflective surface, wherein light emerging from the hollow input waveguide in a first direction is reflected off of the reflective structure in a second direction; and
a hollow output waveguide having an opening disposed proximate to the reflective structure to receive and carry the light reflected in the second direction.

15. The broadcast bus of claim 14 wherein the reflective structure further comprises:
a first reflective surface positioned to reflect the light emerging from the hollow input waveguide in the first direction into a third direction; and
a second reflective surface disposed adjacent to the first reflective surface and positioned to reflect the light propagating in the third direction into the second direction that is substantially opposite the light reflected traveling in the first direction.
